(19) United States
(12) Patent Application Publication
(10) Pub. No.: US 2001/0049712 A1
(43) Pub. Date: Dec. 6, 2001

(54) Archiving in workflow management systems

(75) Inventors: Frank Leymann, Aidlingen (DE); Dieter Roller, Schoenaich (DE)

Correspondence Address: WILLIAM KINNAMAN, JR., IBM Corporation, Intellectual Property Law Department, 2455 South Road, M/S P386, Poughkeepsie, NY, 12601, US

(73) Assignee: INTERNATIONAL BUSINESS MACHINES CORPORATION, ARMONK, NY (US)

(21) Appl. No.: 09/872,878

(22) Filed: Jun. 1, 2001

(30) Foreign Application Priority Data
Jun. 3, 2000 (DE) 00111784.5

(51) Int. Cl. G06F 9/46; G06F 17/30

(52) U.S. Cl. 709/100; 707/204; 709/318

(57) ABSTRACT

A method of optimizing a workflow management system (WFMS), the method being executable by the WFMS on at least one computer system. The WFMS accesses a database comprising of at least one process model and instantiations of the process model (process instances). The method contemplates transferring objects of the database to an archive database (archive function). This transfer is preferably carried out in case that a predetermined event occurs or if these objects are not currently used by the WFMS. Preferably the objects to be transferred to the archive database are process instances. These process instances are preferably selected among all instances of a certain process model depending on the value of certain properties of this process model. The objects of the database which are transferred to the archive database can also be process models. Additionally the data that is managed by the applications that implement the various activities of the process model can be transferred too by having user programs moving the data from the regular application store to an application archive store. Furthermore the method contemplates transferring the WFMS objects back to the WFMS database as well as transferring the data in the application archive store back to the application store when the archived WFMS objects are needed again (restore function).

### BACKGROUND OF THE INVENTION

1. Field of the Invention

The present invention relates to workflow management systems. More particularly the present invention relates to a method of optimizing workflow management systems.

2. Description of the Related Art

A new area of technology with increasing importance is the domain of workflow management systems (WFMSs). WFMSs support the modeling and execution of business processes. Business processes executed within a WFMS environment control which piece of work of a network of pieces of work will be performed by whom and which resources are exploited for this work. The individual pieces of work might be distributed across a multitude of different computer systems connected by some type of network. A thorough representation of WFMS technology is given by Frank Leymann, Dieter Roller, Production Workflow: Concepts and Techniques, Prentice-Hall, Upper Saddle River, N.J., 1999.

The product “IBM MQSeries Workflow” represents such a typical modern, sophisticated, and powerful workflow management system. It supports the modeling of business processes as a network of activities. This network of activities, the process model, is constructed as a directed, acyclic, weighted, colored graph. The nodes of the graph represent the activities which are performed. The edges of the graph, the control connectors, describe the potential sequence of execution of the activities. Definition of the process graph is via the IBM MQSeries Flow Definition Language (FDL) or the built-in graphical editor. The runtime component of the workflow manager interprets the process graph and distributes the execution of activities to the right person at the right place, e.g. by assigning tasks to a work list according to the respective person, wherein the work list is stored as digital data within the workflow or process management computer system.

During operation of the system, the WFMS accesses a database, where the process models and their instantiations, the process instances, are stored. The size of the WFMS database can become very large. The database of the WFMS of a typical e-commerce company for example can easily reach the size of 100 GB.

The disadvantage of such a large database is that the performance associated with accessing of the database gets worse the larger the database becomes.

### SUMMARY OF THE INVENTION

The invention is based on the object to optimize the performance of a WFMS.

This and other objects are achieved by the invention set forth in the independent claims. Further advantageous arrangements and embodiments of the invention are set forth in the respective subclaims.

The invention relates to a method of optimizing a workflow management system (WFMS), the method being executable by the WFMS on at least one computer system. The WFMS accesses a database comprising of at least one process model and instantiations of the process model (process instances). The method contemplates transferring objects of the database to an archive database (archive function). This transfer is preferably carried out if a predetermined event occurs or if these objects are not currently used by the WFMS. Preferably the objects to be transferred to the archive database are process instances. These process instances are preferably selected among all instances of a certain process model depending on the value of certain properties of this process model. The objects of the database which are transferred to the archive database can also be process models. Additionally the data that is managed by the applications that implement the various activities of the process model can be transferred too by having user programs moving the data from the regular application store to an application archive store. Furthermore the method contemplates transferring the WFMS objects back to the WFMS database as well as transferring the data in the application archive store back to the application store when the archived WFMS objects are needed again (restore function).

With the present invention the size of the WFMS database as well as the size of the application stores managed by the activity implementations can be minimized. The most important advantage of the current invention is that the smaller the size of the repository, the better is the performance associated with accessing the database.

By implementing the present invention the performance of the WFMS is improved.

### BRIEF DESCRIPTION OF THE DRAWINGS

FIG. 1 shows a definition of a WFMS system with enabled archive processing according to an embodiment of the present invention.

FIG. 2 shows a definition of a process model with enabled archive processing according to an embodiment of the present invention.

FIG. 3 shows commands to archive and to restore process instances according to an embodiment of the present invention.

FIG. 4 shows a definition of automatic archiving of a process model according to an embodiment of the present invention.

FIG. 5 shows commands to archive and to restore on model level according to an embodiment of the present invention.

FIG. 6 shows a definition of a program for archiving/restoring of associated data and a definition of a process model with archiving/restoring of associated data according to an embodiment of the present invention.

FIG. 7 shows a definition of a process with detailed archiving/restoring of associated data according to a further embodiment of the present invention.

### DESCRIPTION OF THE PREFERRED EMBODIMENT

The current invention is illustrated based on IBM's MQSeries Workflow workflow management system. Of course any other WFMS could be used instead. Furthermore the current teaching applies also to any other type of system which offers WFMS functionalities not as a separate WFMS but within some other type of system.

Introduction

The following is a short outline on the basic concepts of a workflow management system based on IBM's MQSeries Workflow WFMS as far as it is of importance for the current invention:

From an enterprise point of view the management of business processes is becoming increasingly important: business processes or process for short control which piece of work will be performed by whom and which resources are exploited for this work, i.e. a business process describes how an enterprise will achieve its business goals. A WFMS may support both the modeling of business processes and their execution.

Modeling of a business process as a syntactical unit in a way that is directly supported by a software system is extremely desirable. Moreover, the software system can also work as an interpreter basically getting as input such a model: The model, called a process model or workflow model, can then be instantiated and the individual sequence of work steps depending on the context of the instantiation of the model can be determined. Such a model of a business process can be perceived as a template for a class of similar processes performed within an enterprise; it is a schema describing all possible execution variants of a particular kind of business process. An instance of such a model and its interpretation represents an individual process, i.e. a concrete, context-dependent execution of a variant prescribed by the model. A WFMS facilitates the management of business processes. It provides a means to describe models of business processes (build time) and it drives business processes based on an associated model (run time). The meta model of IBM's WFMS MQSeries Workflow, i.e. the syntactical elements provided for describing business process models, and the meaning and interpretation of these syntactical elements, is described next.

A process model is a complete representation of a process, comprising a process diagram and the settings that define the logic behind the components of the diagram. Important components of a MQSeries Workflow process model are:

Processes

Activities

Blocks

Control Flows

Connectors

Data Containers

Data Structures

Programs

Staff

Not all of these elements will be described below.

Activities are the fundamental elements of the meta model. An activity represents a business action that is from a certain perspective a semantic entity of its own.

A MQSeries Workflow process model consists of the following types of activities:

Program activity: Has a program assigned to perform it. The program is invoked when the activity is started. In a fully automated workflow, the program performs the activity without human intervention. Otherwise, the user must start the activity by selecting it from a runtime work list.

Process activity: Has a (sub-)process assigned to perform it. The process is invoked when the activity is started. A process activity represents a way to reuse a set of activities that are common to different processes.

The flow of control, i.e. the control flow through a running process determines, the sequence in which activities are executed. The MQSeries Workflow workflow manager navigates a path through the process.

The results that are in general produced by the work represented by an activity is put into an output container, which is associated with each activity. Since an activity will in general require accessing output containers of other activities, each activity is associated in addition with an input container too.

Connectors link activities in a process model. Using connectors, one defines the sequence of activities and the transmission of data between activities. Since activities might not be executed arbitrarily they are bound together via control connectors. A control connector might be perceived as a directed edge between two activities; the activity at the connector's end point cannot start before the activity at the start point of the connector has finished (successfully). Control connectors model thus the potential flow of control within a business process model. Data connectors specify the flow of data in a workflow model. A data connector originates from an activity or a block and has an activity or a block as its target. One can specify that output data is to go to one target or to multiple targets. A target can have more than one incoming data connector.

Process definition includes modeling of activities, control connectors between the activities, input/output containers, and data connectors. A process is represented as a directed acyclic graph with the activities as nodes and the control/data connectors as the edges of the graph. The graph is manipulated via a built-in graphic editor. The data containers are specified as named data structures. These data structures themselves are specified via the DataStructureDefinition facility. Program activities are implemented through programs. The programs are registered via the Program Definition facility. Blocks contain the same constructs as processes, such as activities, control connectors etc. Process activities are implemented as processes. These subprocesses are defined separately as regular, named processes with all their usual properties. Process activities offer great flexibility for process definition. It allows not only constructing a process through permanent refinement of activities into program and process activities (top-down), but also building a process out of a set of existing processes (bottom-up).

All programs which implement program activities are defined via the Program Registration Facility. Registered for each program are the name of the program, its location, and the invocation string. The invocation string consists of the program name and the command string passed to the program.

Preparing Archiving

The present invention uses an archive database in order to store data to be archived. The archive database has the same structure as the normal database. The archive database is preferably located on a different device than the normal database. This provides for better performance when accessing both databases. It is typically allocated by the WFMS automatically when archiving for the WFMS is enabled. Other options are deferring the allocation until archiving is actually carried out.

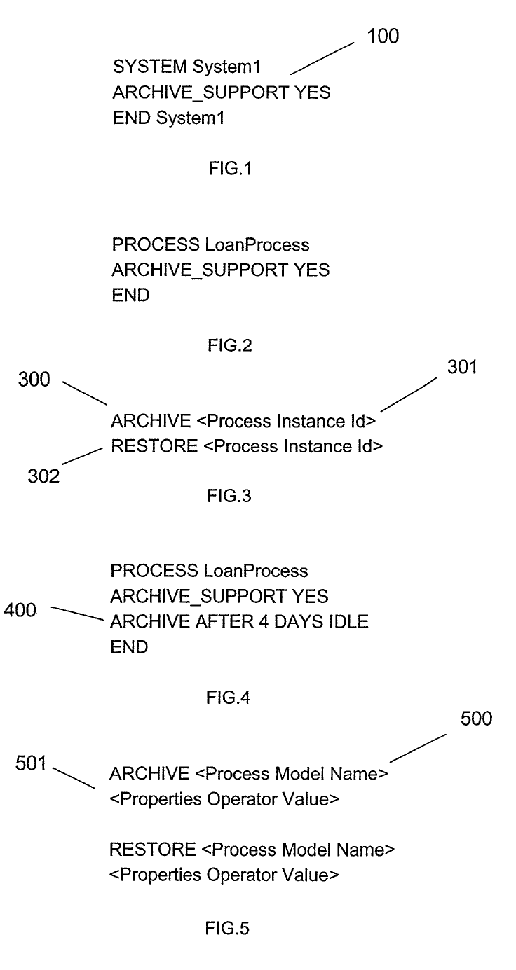

In a preferred embodiment of the invention the enabling of the archive/restore function of the WFMS is performed using a definition as shown in FIG. 1. For this purpose a new keyword ARCHIVE_SUPPORT 100 is added to the specification of the WFMS system. This keyword 100 is used to specify whether archiving for the WFMS System1 is enabled (ARCHIVE_SUPPORT YES) or not (ARCHIVE_SUPPORT NO). It should be noted that as an example in all figures of this description the Flow Definition Language (FDL) of MQSeries Workflow is used.

Archiving and restoring of business processes requires additional processing on the side of the WFMS. This additional processing is, for example, to keep information in the WFMS's database that otherwise would be discarded, or to check whether an archived version exists for a business process. For this reason it must be ensured that archiving and restoring are valid operations for a particular process instance. FIG. 2 shows how the archiving for a process model, e.g. a loan process carried out in a bank, is enabled. Thus preferably the same keyword 100 as illustrated in FIG. 1 is used.

Archiving of Process Instances

When a process model is defined as archiveable, a particular process instance can be archived and restored. To archive and restore a process instance new commands are added to the specification of the process model. FIG. 3 shows some of the typical commands of a preferred embodiment. Thus the command ARCHIVE 300 archives a process instance with a given process instance identifier 301, whereas the command RESTORE 302 restores a process instance.

Archiving means the move of all information about a particular process instance from the WFMS database into the archive database. This moved information may also include the information about the process model that is used to carry out the particular process instance. Restoring means the move of all information about a particular instance from the archive database to the WFMS database. This moved information may also includes the information about the process model that is used to carry out the particular process instance.

Archiving/restoring is preferably carried out by a special designed archive/restore component which is part of the WFMS. Alternatively the archive/restore component can be implemented as an external component (e.g. a ‘plug-in’ component).

Quite often parts of a process model are carried out automatically, that means without user intervention. Then performing archiving and restoring via commands can only be an option to be used sparingly, since this approach requires interactions from the end user or administrator, performed e.g. via an appropriate programming interface.

Alternatively archiving can be defined as a time-controlled activity for a particular process model. FIG. 4 shows the corresponding definition for this approach. For this purpose the new keyword ARCHIVE 400 is added to the specification of the WFMS system. The ARCHIVE keyword 400 allows specifying when automatic archiving should occur. In the described example it defines that a particular process instance of the process model ‘Loan Process’ is archived when the process instance is idle for more than four days. The specification for the ARCHIVE keyword is not limited to being able to specify a particular time, but could be any arbitrary complex Boolean expression. In this case, archiving is performed if the Boolean expression evaluates to true.

Whereas archiving can be performed automatically according to the above embodiment, the restoring part would normally not be performed automatically. In most cases it will be sufficient to perform the restoring via an explicit call, e.g. the command of a user or the occurrence of a defined event. For example the restoring is performed if the WFMS requests to use the archived material, i.e. this material is transferred back to the WFMS database if it is needed again.

Context Based Archiving

Whereas in FIG. 3 the archiving/restoring has been described with regard to the process instance level, the method of archiving/restoring can be applied to a collection of process instances i.e. to the process model level as well.

In this embodiment all process instances of a particular process model having certain properties are archived, e.g. all process instances with a loan larger than $10.000. For this purpose the appropriate instances of a process model have to be selected.

FIG. 5 shows a preferred embodiment of corresponding archive and restore commands. Thus <Process Model Name> 500 identifies the process model. The selection is performed using the <Properties Operator Value> 501, which specifies the values that process instances of the specified process model must meet.

Properties can be any property that the user defines for the process model as well as properties automatically managed by the WFMS. User-defined properties are defined as fields in the input or output container of the process model or the input and output container of an activity. Assuming that the process input container of the process model LOAN_PROCESS contains a field LOAN_AMOUNT, which contains the associated loan amount, then the specification (ProcessInputContainer.LOAN_AMOUNT>50000) would select all process instances of the process model LOAN_PROCESS where the loan amount is greater $50.000. A typical system-managed property is the date the process instance was started. Thus a specification (START_DATE<4/10/99) would select all process instances that have been started before Oct. 10, 1999.

The <Properties Operator Value> 501 can comprise an arbitrary complex Boolean expression. Depending on the truth value of this Boolean predicate the WFMS performs the archiving/restoring of the process instances of the process model defined by <Process Model Name> 500.

In a further embodiment of the invention not only the process instances but the process models themselves are archived/restored. This is especially applicable if all process instantiations of a particular process model are already archived.

Archiving of Associated Data

Archiving process instances as described above however may not be sufficient. Workflow-based applications consist of a process model and the appropriate activity implementations. These activity implementations also manage data. For a complete archive, the data managed by the activity implementation is also archived. If, for example, an activity implementation manages customer records, then the customer record managed for a particular process instance should also be archived. Thus preferably that data is archived which is managed by the programs that implemented the activities of the process model from which process instances are transferred to the archive database.

The data managed by the activity implementation is maintained in an application store, which can be any data store. Because the WFMS normally has no knowledge about the data managed by the activity implementation, e.g. their location, special designed means, e.g. programs, are utilized to move the data from the regular application store to an application archive store and vice versa. Preferably the application archive store is located on a different device than the application store.

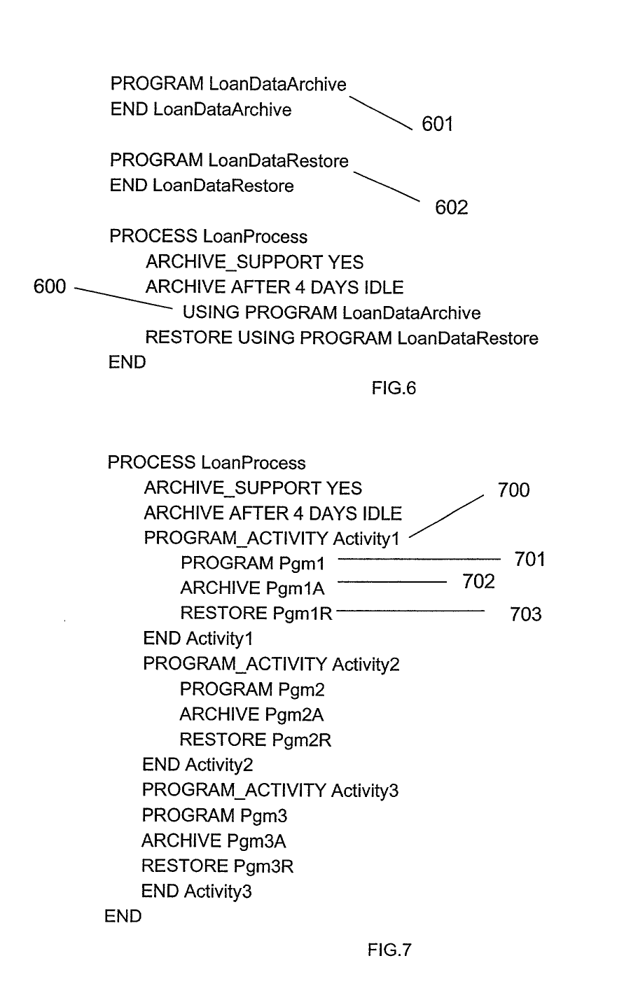

FIG. 6 shows a preferred embodiment of the invention where data associated with a process is archived. Thus the USING PROGRAM keyword 600 identifies the program 601, 602 that is called when a business process is archived or restored. Application programing interfaces provide the called programs 601, 602 with appropriate data, such as container contents, so that the programs can take the appropriate actions.

In the embodiment the archive/restore program pair 601, 602 is used to archive/restore all activities of the process model ‘Loan Process’. That means that these programs 601, 602 must know the complete structure of the process to be archived/restored. Therefore these programs are relatively complex.

An even further improved approach is described next. FIG. 7 shows such a preferred embodiment, where detailed archiving of associated data is performed. Thus each program 701 (Pgm1, Pgm2, Pgm3) of an activity 700 (Activity1, Activity2, Activity3) is associated with an archive program 702 (Pgm1A, Pgm2A, Pgm3A) and a restore program 703 (Pgm1R, Pgm2R, Pgm3R).

During normal execution of the loan process the activities 1, 2 and 3, i.e. the programs Pgm1, Pgm2 and Pgm3, are executed. If the process is archived, then the WFMS reverses the executed graph and carries out this new graph by invoking the appropriate programs defined via the ARCHIVE keyword. If, for example, the process is archived after execution of Activity2, then the WFMS invokes the programs Pgm2A and Pgm1A during archiving. Similiarly, the programs Pgm1R and Pgm2R are invoked when the business process is restored.

In a further embodiment of the invention the program versions of the programs Pgm1, Pgm2 and Pgm3 are archived additionally to the associated data. By archiving the program versions it is ensured that after restoring the process is carried out using the same program versions as used at the time prior to archiving.

The present invention can be realized in hardware, software, or a combination of hardware and software. A WFMS according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when loaded and executed, controls the computer system such that it carries out the methods described herein. The present invention can also be embedded in a computer program product, which comprises all the features enabling the implementation of the methods described herein, and which when loaded in a computer system is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

What is claimed is:

1. A method of optimizing a workflow management system (WFMS), said method being executable by said WFMS on at least one computer system, said WFMS accessing a WFMS database comprising at least one process model and instantiations of said process model (process instances), said method comprising the step of transferring objects of the WFMS database to an archive database.

2. The method of claim 1 in which the step of transferring objects of the WFMS database to the archive database is carried out if a predetermined event occurs.

3. The method of claim 1 in which the step of transferring objects of the WFMS database to the archive database is carried out if the objects are not currently used by the WFMS.

4. The method of claim 1 in which the objects transferred to the archive database comprise process instances.

5. The method of claim 4 in which the process instances transferred to the archive database are selected among instances of a certain process model depending on the value of certain properties of the process model.

6. The method of claim 4 comprising the further step of transferring from an application store to an application archive store data which is managed by programs that implement activities of a process model from which process instances are transferred to the archive database.

7. The method of claim 6 comprising the further step of transferring the data from the application archive store back to the application store.

8. The method of claim 1 in which the objects transferred to the archive database comprise process models.

9. The method of claim 1 comprising the further step of transferring the objects back to the WFMS database.

10. The method of claim 9 in which the objects are transferred back to the WFMS database when they are needed again.

11. A system comprising means adapted for carrying out the steps of the method of claim 1 whereas the system comprises an archiving database.

12. A data processing program comprising software code portions for performing the method of claim 1 when the program is executed in a data processing system.

13. A computer program product comprising computer readable program means for causing a computer to perform the method of claim 1 when the program is executed in a computer.
